(19) United States
(12) Patent Application Publication
(10) Pub. No.: US 2024/0128588 A1
(43) Pub. Date: Apr. 18, 2024

(54) SEPARATOR AND BATTERY COMPRISING SAME

(71) Applicant: ZHUHAI COSMX BATTERY CO., LTD., Zhuhai (CN)

(72) Inventors: Yingdi MU, Zhuhai (CN); Zulai ZHANG, Zhuhai (CN); Hai WANG, Zhuhai (CN); Suli LI, Zhuhai (CN)

(73) Assignee: ZHUHAI COSMX BATTERY CO., LTD., Zhuhai (CN)

(21) Appl. No.: 18/398,594

(22) Filed: Dec. 28, 2023

Related U.S. Application Data
(63) Continuation of application No. PCT/CN2022/127484, filed on Oct. 25, 2022.

(30) Foreign Application Priority Data
Oct. 25, 2021 (CN) 202111241330.6
Oct. 25, 2021 (CN) 202111243132.3
Oct. 25, 2021 (CN) 202111251994.0

(51) Int. Cl. H01M 50/451; H01M 4/62; H01M 10/0525; H01M 10/0567; H01M 10/0568; H01M 10/0569; H01M 50/434

(52) U.S. Cl. CPC H01M 50/451; H01M 4/623; H01M 10/0525; H01M 10/0567; H01M 10/0568; H01M 10/0569; H01M 50/434

(57) ABSTRACT

Disclosed is a separator and a battery including the separator. The separator includes a substrate, heat-resistant layers, and an adhesive layer, the heat-resistant layers are disposed on two opposite surfaces of the substrate, and the adhesive layer is disposed on the heat-resistant layer; and an adhesive force between the adhesive layer and negative electrode is A, a peel force between a heat-resistant layer and the substrate is B, and a ratio of A to B is greater than 1. In the present disclosure, heat-resistant layers of a separator are bonded to a surface of negative electrode, so that it is difficult for the positive electrode and the negative electrode to be shorted at a high temperature, thereby improving safety performance of a battery.

### CROSS-REFERENCE TO RELATED APPLICATIONS

The present disclosure is a continuation of International Application No. PCT/CN2022/127484, filed on Oct. 25, 2022, which claims priority to Chinese Patent Application No. 202111251994.0, filed on Oct. 25, 2021, Chinese Patent Application No. 202111241330.6, filed on Oct. 25, 2021, and Chinese Patent Application No. 202111243132.3, filed on Oct. 25, 2021. All of the aforementioned patent applications are hereby incorporated by reference in their entireties.

### TECHNICAL FIELD

The present disclosure pertains to the field of batteries, and relates to a separator and a battery including the separator.

### BACKGROUND

In recent years, lithium-ion batteries have been widely used in a smartphone, a tablet computer, intelligent wearing, an electric tool, an electric vehicle, and other fields. With increasing application of lithium-ion batteries, use environment and requirements of consumers for lithium-ion batteries are constantly improving. This requires that lithium-ion batteries have high safety while taking into account high and low temperature performance.

Currently, there is a potential safety hazard in a use process of lithium-ion batteries. For example, when a battery is in some extreme use cases such as a continuous high temperature, a serious safety accident such as a fire or even an explosion may occur. The problem is mainly caused by the following two aspects: In one aspect, a structure of a positive electrode material is unstable at high temperature and high voltage, metal ions are easily dissolved from the positive electrode and reduced and deposited on a negative electrode surface, thereby destroying a solid electrolyte interphase (SEI) film structure on the negative electrode surface, and resulting in an increasing negative electrode impedance and an increasing battery thickness. A large amount of heat is released from a violent reaction between an electrolyte solution and lithium graphite, to make a temperature of a cell continuously increase, and a safety accident is caused when heat is continuously accumulated and cannot be released. In the other aspect, heat shrinkage of a separator at high temperature leads to short circuit between the positive and negative electrodes, thereby significantly reducing safety performance of the battery.

To overcome the foregoing technical problems, a lithium-ion battery with high safety and high voltage needs to be developed urgently. Currently, a ceramic layer is coated on a surface of a polyolefin substrate, and a flame retardant (such as trimethyl phosphate) is added to an electrolyte solution to improve safety performance of a battery. However, a method of only using a ceramic separator cannot meet safety performance of a battery in a high-voltage system, and a method of adding the flame retardant additive often causes deterioration of battery performance, severely shortening a battery life. Therefore, how to develop a battery without affecting electrochemical performance in high voltage and having high safety is a technical problem that needs to be urgently solved in the field of lithium-ion batteries.

### SUMMARY

To improve the foregoing technical problems, the present disclosure provides a separator and a battery including the separator, and the battery has both high safety performance and high voltage.

To implement the foregoing objectives, the following technical solutions are used in the present disclosure.

A first aspect of the present disclosure provides a separator. The separator includes a substrate, heat-resistant layers, and an adhesive layer, the heat-resistant layers are disposed on two opposite surfaces of the substrate, and the adhesive layer is disposed on the heat-resistant layer. An adhesive force between the adhesive layer and negative electrode is A, a peel force between a heat-resistant layer and the substrate is B, and a ratio of A to B (A/B) is greater than 1.

According to the separator provided in the first aspect of the present disclosure, the ratio of A to B ranges from 2.5 to 6.5, for example, is 2.5, 2.7, 3.0, 3.3, 3.5, 4.0, 4.5, 4.8, 5.0, 5.3, 5.5, 6.0, 6.2, 6.4, or 6.5.

According to the separator provided in the first aspect of the present disclosure, a thickness of the heat-resistant layer ranges from 1 μm to 5 μm, for example, is 1 μm, 2 μm, 3 μm, 4 μm, or 5 μm.

According to the separator provided in the first aspect of the present disclosure, a heat shrinkage of the heat-resistant layer at 150° C. for 1 hour is less than or equal to 5%, for example, is 5%, 4%, 3%, 2.5%, 2%, 1.5%, 1%, or 0.5%.

According to the separator provided in the first aspect of the present disclosure, the adhesive force A between the adhesive layer and the negative electrode is greater than or equal to 10 N/m.

According to the separator provided in the first aspect of the present disclosure, the peel force B between the heat-resistant layer and the substrate is 5 N/m or less.

According to the separator provided in the first aspect of the present disclosure, after a battery cell containing the separator in the present disclosure is applied with a pressure ranging from 0.6 Mpa to 3.0 MPa, a current ranging from 0.01C to 1C, a hot-pressing time ranging from 30 minutes to 300 minutes in a temperature ranging from 70° C. to 90° C., the heat-resistant layer and the adhesive layer are separated from the substrate as a whole and are transferred and bonded to the active material layer of the negative electrode plate, and the probability of transfer bonding is 30%, where the adhesive layer is in contact with the negative electrode plate, and the heat-resistant layer is transferred and bonded to the negative electrode plate by using the adhesive layer (heat-resistant layer content on an electrode plate).

According to the separator provided in the first aspect of the present disclosure, a thickness of the heat-resistant layer and the adhesive layer that are transferred and bonded to the negative electrode plate plus a thickness of the separator in a corresponding region is equal to a thickness of the separator on which the heat-resistant layer and the adhesive layer are not transferred.

According to the separator provided in the first aspect of the present disclosure, the substrate is selected from one, two, or more of polymer polyethylene, polypropylene, polyethylene terephthalate, polybutylene terephthalate, polystyrene, poly(p-phenylene), polyphenylene, polyimide, polyamide, aramid, or poly(p-phenylene benzobisthiazole).

According to the separator provided in the first aspect of the present disclosure, the heat-resistant layer includes a ceramic, a heat-resistant polymer, and a binder.

Preferably, in the heat-resistant layer, a mass proportion of the ceramic ranges from 5 wt % to 20 wt %, and for example, is 5 wt %, 10 wt %, 15 wt %, 20 wt %, or a point value in a range formed by any two of the foregoing values.

Preferably, in the heat-resistant layer, a mass proportion of the heat-resistant polymer ranges from 60 wt % to 94 wt %, for example, is 60 wt %, 70 wt %, 80 wt %, 90 wt %, 94 wt %, or a point value in a range formed by any two of the foregoing values.

Preferably, in the heat-resistant layer, amass proportion of the binder ranges from 0.5 wt % to 20 wt %, for example, is 0.5 wt %, 1 wt %, 5 wt %, 10 wt %, 15 wt %, 20 wt %, or a point value in a range formed by any two of the foregoing values.

According to the separator provided in the first aspect of the present disclosure, the ceramic is selected from one, two, or more of silica, aluminum oxide, zirconium dioxide, magnesium hydroxide, boehmite, barium sulfate, fluorphlogopite, fluorapatite, mullite, cordierite, aluminum titanate, titanium dioxide, copper oxide, zinc oxide, boron nitride, aluminum nitride, magnesium nitride, or attapulgite.

According to the separator provided in the first aspect of the present disclosure, the heat-resistant polymer is selected from one, two, or more of polyimide, aramid resin, polyamide, and polybenzimidazole, polyphenyl ester, polyborodiphenylsiloxane, polyphenylene sulfide, chlorinated polyether, or polyarylsulfone.

According to the separator provided in the first aspect of the present disclosure, the binder is selected from one, two, or more of polytetrafluoroethylene, polyvinylidene fluoride, hexafluoropropylene modified polyvinylidene fluoride, a hexafluoropropylene-vinylidene fluoride copolymer (for example, a polyvinylidene fluoride-hexafluoropropylene copolymer), polyimide, polyacrylonitrile, polymethyl methacrylate, cellulose acetate, butyl acetate cellulose, propyl acetate cellulose, cyanoethyl amylopectin, cyanoethyl polyvinyl alcohol, cyanoethyl cellulose, cyanoethyl sucrose, amylopectin, carboxymethyl cellulose, or an acrylonitrile styrene butadiene copolymer.

According to the separator provided in the first aspect of the present disclosure, a thickness of the adhesive layer ranges from 0.5 μm to 2 μm, and for example, is 0.5 μm, 1 μm, or 2 μm.

According to the separator provided in the first aspect of the present disclosure, the adhesive layer includes an adhesive polymer, and the adhesive copolymer used in the adhesive layer is selected from one, two, or more of polytetrafluoroethylene, polyvinylidene fluoride, a polyvinylidene fluoride-hexafluoropropylene copolymer, hexafluoropropylene modified polyvinylidene fluoride, polyimide, polyacrylonitrile, polymethyl methacrylate, cellulose acetate, butyl acetate cellulose, propyl acetate cellulose, cyanoethyl amylopectin, cyanoethyl polyvinyl alcohol, cyanoethyl cellulose, cyanoethyl sucrose, amylopectin, carboxymethyl cellulose, or an acrylonitrile styrene butadiene copolymer.

According to the separator provided in the first aspect of the present disclosure, in the adhesive layer, a mass proportion of the adhesive polymer ranges from 40 wt % to 100 wt %, for example, is 40 wt %, 50 wt %, 60 wt %, 70 wt %, 80 wt %, 90 wt %, 100 wt %, or a point value in a range formed by any two of the foregoing values.

According to the separator provided in the first aspect of the present disclosure, a slurry for preparing the heat-resistant layer and the adhesive layer includes a solvent, and the solvent used for preparing the heat-resistant layer and the adhesive layer is selected from at least one of N,N-dimethylacetamide (DMAC), acetone, tetrahydrofuran, dichloromethane, chloroform, dimethylformamide, N-methyl-2-pyrrolidone, cyclohexane, methanol, ethanol, isopropanol, or water.

A second aspect of the present disclosure provides a battery, and the battery includes the foregoing separator.

According to the battery provided in the second aspect of the present disclosure, the battery further includes a positive electrode plate, a negative electrode plate, and a non-aqueous electrolyte solution. The foregoing separator is disposed between the positive electrode plate and the negative electrode plate. The battery in the present disclosure may be, for example, a lithium-ion battery. FIG. 1 is a schematic diagram of a partial cross-section of a lithium-ion battery according to the present disclosure.

According to the battery provided in the second aspect of the present disclosure, the non-aqueous electrolyte solution includes a non-aqueous organic solvent and an additive, where the non-aqueous organic solvent includes ethyl propionate.

According to the battery provided in the second aspect of the present disclosure, the additive is selected from non-aqueous electrolyte additives known in the art. The additives may be prepared by using a method known in the art, or may be purchased commercially.

According to the battery provided in the second aspect of the present disclosure, an addition amount of the ethyl propionate is 10-50 wt % of a total mass of the non-aqueous electrolyte solution, preferably, ranges from 20 wt % to 40 wt %, for example, is 10 wt %, 15 wt %, 20 wt %, 25 wt %, 30 wt %, 35 wt %, 40 wt %, 45 wt %, or 50 wt %.

A third aspect of the present disclosure further provides a battery, including a positive electrode plate, a negative electrode plate, a separator disposed between the positive electrode plate and the negative electrode plate, and a non-aqueous electrolyte solution.

The separator includes a substrate, heat-resistant layers, and adhesive layers, the heat-resistant layers are disposed on two opposite surfaces of the substrate, and the adhesive layer is disposed on the heat-resistant layer. An adhesive force between the adhesive layer and negative electrode is A, a peel force between the heat-resistant layer and the substrate is B, and a ratio of A to B is greater than 1.

The non-aqueous electrolyte solution includes a non-aqueous organic solvent and an additive, where the non-aqueous organic solvent includes ethyl propionate, and the additive includes a carbonate compound.

According to the battery provided in the third aspect of the present disclosure, the carbonate compound may be selected from at least one of fluoroethylene carbonate, vinylene carbonate, or vinyl ethylene carbonate.

According to the battery provided in the third aspect of the present disclosure, in the non-aqueous electrolyte solution, an addition amount of the carbonate compound accounts for 1-10 wt % of a total mass of the non-aqueous electrolyte solution, preferably, ranges from 5 wt % to 10 wt %, for example, is 1 wt %, 2 wt %, 3 wt %, 3.5 wt %, 4 wt %, 4.5 wt %, 5 wt %, 6 wt %, 6.5 wt %, 7 wt %, 7.8 wt %, 8 wt %, 9 wt %, 10 wt %, or a point value in a range formed by any two of the foregoing values.

According to the battery provided in the third aspect of the present disclosure, the ratio of A to B ranges from 1.5 to 6.0, and for example, is 1.5, 2.0, 2.5, 3.0, 3.5, 4.0, 4.5, 5.0, 5.5, 6.0, or a point value in a range formed by any two of the foregoing values.

A fourth aspect of the present disclosure further provides a battery, including a positive electrode plate, a negative electrode plate, a separator disposed between the positive electrode plate and the negative electrode plate, and a non-aqueous electrolyte solution.

The separator includes a substrate, heat-resistant layers, and an adhesive layer, the heat-resistant layers are disposed on two opposite surfaces of the substrate, and the adhesive layer is disposed on the heat-resistant layer. An adhesive force between the adhesive layer and negative electrode is A, a peel force between a heat-resistant layer and the substrate is B, and a ratio of A to B is greater than 1.

The non-aqueous electrolyte solution includes a non-aqueous organic solvent and an additive, where the non-aqueous organic solvent includes ethyl propionate, and the additive includes a compound including a nitrile group.

It should be noted that the foregoing compound that includes a nitrile group refers to a compound that includes a cyano group.

According to the battery in the fourth aspect of the present disclosure, the compound including a nitrile group may be selected from at least one of succinonitrile, glutaronitrile, adiponitrile, 1,5-dicyanopentane, 1,6-dicyanohexane, 1,7-dicyanoheptane, 1,8-dicyanooctane, 1,9-dicyanononane, 1,10-dicyanodecane, 1,12-dicyanododecane, tetramethylbutadionitrile, 2-methylglutaronitrile, 2,4-dimethylglutaronitrile, 2,2,4,4-Tetramethylglutaronitrile, 1,4-dicyanopentane, 2,6-dicyanoheptane, 2,7-dicyanooctane, 2,8-dicyanononane, 1,6-dicyanodecane, 1,2-dicyanobenzene, 1,3-dicyanobenzene, 1,4-dicyanobenzene, 3,5-dioxa-heptadionitrile, 1,4-bis(cyanoethoxy)butane, ethylene glycol bis(2-cyanoethyl) ether, diethylene glycol bis(2-cyanoethyl) ether, triethylene glycol bis(2-cyanoethyl) ether, tetraethylene glycol bis(2-cyanoethyl) ether, 3,6,9,12,15,18-hexaoxeicosanic acid dinitrile, 1,3-bis(2-cyanoethoxy)propane, 1,4-bis(2-cyanoethoxy) butane, 1,5-bis(2-cyanoethoxy)pentane, ethylene glycol bis(4-cyanobutyl) ether, 1,4-dicyano-2-butene, 1,4-dicyano-2-methyl-2-butene, 1,4-dicyano-2-ethyl-2-butene, 1,4-dicyano-2,3-dimethyl-2-butene, 1,4-dicyano-2,3-diethyl-2-butene, 1,6-dicyano-3-hexene, 1,6-dicyano-2-methyl-3-hexene, 1,6-dicyano-2-methyl-5-methyl-3-hexene, 1,3,5-pentatrionitrile, 1,2,3-propanetricarbonitrile, 1,3,6-hexane trinitrile, glycerol trinitrile, 1,2,6-hexane trinitrile, 1,2,3-tri(2-cyanoethoxy)propane, 1,2,4-tri(2-cyanoethoxy) butane, 1,1,1-tri(cyanoethoxymethylene)ethane, 1,1,1-tri(cyanoethoxymethylene)propane, 3-methyl-1,3,5-tri(cyanoethoxy)pentane, 1,2,7-tri(cyanoethoxy)heptane, 1,2,6-tri(cyanoethoxy) hexane, or 1,2,5-tri(cyanoethoxy)pentane.

According to the battery provided in the fourth aspect of the present disclosure, in the non-aqueous electrolyte solution, an addition amount of the compound including a nitrile group accounts for 1-10 wt % of a total mass of the non-aqueous electrolyte solution, preferably, ranges from 2 wt % to 5 wt %, for example, is 1 wt %, 2 wt %, 3 wt %, 3.5 wt %, 4 wt %, 4.5 wt %, 5 wt %, 5.5 wt %, 6 wt %, 7 wt %, 8 wt %, 9 wt %, 10 wt %, or a point value in a range formed by any two of the foregoing values.

According to the battery provided in the fourth aspect of the present disclosure, the ratio (A/B) of A to B ranges from 1.5 to 4.5, and for example, is 1.5, 2.0, 2.5, 3.0, 3.5, 4.0, 4.5, or a point value in a range formed by any two of the foregoing values.

According to the batteries provided in the third aspect and the fourth aspect of the present disclosure, an addition amount of the ethyl propionate is 10-40 wt % of a total mass of the non-aqueous electrolyte solution, preferably, ranges from 20 wt % to 40 wt %, for example, is 10 wt %, 15 wt %, 20 wt %, 25 wt %, 30 wt %, 35 wt %, 40 wt %, or a point value in a range formed by any two of the foregoing values.

According to the batteries provided in the third aspect and the fourth aspect of the present disclosure, the additive further optionally includes another additive, for example, the another additive may be at least one of tris(trimethylsilane) phosphite, tris(trimethylsilyl) borate, lithium bis(trifluoromethanesulphonyl)imide, lithium bis(fluorosulfonyl)imide, 1,3-propanesulfonate, 1,3-propenesultone, ethylene sulphite, ethylene sulfate, vinylene carbonate, fluoroethylene carbonate, lithium bis(oxalate)borate, lithium difluoro(oxalate)borate, lithium difluoro(oxalate) phosphate or vinyl ethylene carbonate.

Preferably, an addition amount of the another additive accounts for 0-10 wt % of a total mass of the non-aqueous electrolyte solution, for example, is 0 wt %, 1 wt %, 2 wt %, 5 wt %, 8 wt %, 10 wt %, or a point value in a range formed by any two of the foregoing values.

According to the batteries provided in the third aspect and the fourth aspect of the present disclosure, the additives may be prepared by using a method known in the art, or may be purchased commercially.

According to the batteries provided in the third aspect and the fourth aspect of the present disclosure, a thickness of the heat-resistant layer ranges from 1 μm to 3 μm, and for example, is 1 μm, 2 μm, or 3 μm.

According to the batteries provided in the third aspect and the fourth aspect of the present disclosure, a heat shrinkage of the heat-resistant layer at 150° C. for 1 hour is less than or equal to 5%, for example, is 5%, 4%, 3%, 2%, or 1%.

According to the batteries provided in the third aspect and the fourth aspect of the present disclosure, an adhesive force between the adhesive layer and the negative electrode is greater than or equal to 10 N/m.

According to the battery provided in the third aspect and the fourth aspect of the present disclosure, a peel force between the heat-resistant layer and the substrate is less than 5 N/m.

According to the batteries provided in the third aspect and the fourth aspect of the present disclosure, after a battery cell containing the separator in the present disclosure is applied with a pressure ranging from 0.6 Mpa to 3.0 MPa, a current ranging from 0.01C to 1C, a hot-pressing time ranging from 30 minutes to 300 minutes in a temperature ranging from 70° C. to 90° C., the heat-resistant layer and the adhesive layer are separated from the substrate as a whole and are transferred and bonded to the active material layer of the negative electrode plate, and the probability of transfer bonding is 30%, where the adhesive layer is in contact with the negative electrode plate, and the heat-resistant layer is transferred and bonded to the negative electrode plate by using the adhesive layer (heat-resistant layer content on an electrode plate).

According to the batteries provided in the third aspect and the fourth aspect of the present disclosure, a thickness of the heat-resistant layer and the adhesive layer that are transferred and bonded to the negative electrode plus a thickness of the separator in a corresponding region is equal to a thickness of the separator on which the heat-resistant layer and the adhesive layer are not transferred.

According to the batteries provided in the third aspect and the fourth aspect of the present disclosure, the substrate is selected from one, two, or more of polyethylene, polypropylene, polyimide, polyamide, or aramid.

According to the batteries provided in the third aspect and the fourth aspect of the present disclosure, the heat-resistant layer includes a ceramic, a heat-resistant polymer, and a binder.

Preferably, in the heat-resistant layer, a proportion of the ceramic ranges from 5 wt % to 20 wt %, and for example, is 5 wt %, 10 wt %, 15 wt %, 20 wt %, or a point value in a range formed by any two of the foregoing values.

Preferably, in the heat-resistant layer, a proportion of the heat-resistant polymer ranges from 60 wt % to 94 wt %, for example, is 60 wt %, 70 wt %, 80 wt %, 90 wt %, 94 wt %, or a point value in a range formed by any two of the foregoing values.

Preferably, in the heat-resistant layer, a proportion of the binder ranges from 0.5 wt % to 20 wt %, for example, is 0.5 wt %, 1 wt %, 1.5 wt %, 3 wt %, 4 wt %, 5 wt %, 6 wt %, 8 wt %, 10 wt %, 15 wt %, 20 wt %, or a point value in a range formed by any two of the foregoing values.

According to the batteries provided in the third aspect and the fourth aspect of the present disclosure, the ceramic is selected from one, two, or more of aluminum oxide, boehmite, magnesium oxide, boron nitride, or magnesium hydroxide.

According to the batteries provided in the third aspect and the fourth aspect of the present disclosure, the heat-resistant polymer is selected from one or two of polyimide, aramid resin, polyamide, or polybenzimidazole.

According to the batteries provided in the third aspect and the fourth aspect of the present disclosure, the binder is selected from one, two, or more of polytetrafluoroethylene, polyvinylidene fluoride, polyvinylidene fluoride-hexafluoropropylene modification and a copolymer thereof, polyimide, polyacrylonitrile, or polymethyl methacrylate.

According to the batteries provided in the third aspect and the fourth aspect of the present disclosure, a thickness of the adhesive layer ranges from 0.5 μm to 2 μm, and for example, is 0.5 μm, 1 μm, or 2 μm.

According to the batteries provided in the third aspect and the fourth aspect of the present disclosure, the adhesive layer includes an adhesive polymer, and the adhesive polymer used in the adhesive layer is selected from one, two, or more of polytetrafluoroethylene, polyvinylidene fluoride, a polyvinylidene fluoride-hexafluoropropylene copolymer and a modified copolymer thereof, polyimide, polyacrylonitrile, or polymethyl methacrylate.

According to the separator provided in the third aspect of the present disclosure, in the adhesive layer, a mass proportion of the adhesive polymer ranges from 40 wt % to 100 wt %, for example, is 40 wt %, 50 wt %, 60 wt %, 70 wt %, 80 wt %, 90 wt %, 100 wt %, or a point value in a range formed by any two of the foregoing values.

According to the batteries provided in the third aspect and the fourth aspect of the present disclosure, a slurry for preparing the heat-resistant layer and the adhesive layer includes a solvent, and the solvent used for preparing the heat-resistant layer and the adhesive layer is selected from at least one of acetone, tetrahydrofuran, dichloromethane, chloroform, dimethylformamide, N-methyl-2-pyrrolidone, cyclohexane, methanol, ethanol, isopropanol, or water.

According to the batteries provided in the second aspect, the third aspect, and the fourth aspect of the present disclosure, the non-aqueous organic solvent further includes at least one of ethylene carbonate (EC), propylene carbonate (PC), dimethyl carbonate, diethyl carbonate, ethyl methyl carbonate, propyl propionate (PP), or propyl acetate, and preferably, includes ethylene carbonate (EC), propylene carbonate (PC), and propyl propionate (PP).

According to an exemplary implementation of the batteries provided in the second aspect and the fourth aspects of the present disclosure, the ethylene carbonate (EC), propylene carbonate (PC), and propyl propionate (PP) are mixed at a mass ratio of 2:1:2. According to an exemplary implementation of the battery according to the third aspect of the present disclosure, the ethylene carbonate (EC), propylene carbonate (PC), and propyl propionate (PP) are mixed at a mass ratio of 1:1:1.

According to the batteries provided in the second aspect, the third aspect, and the fourth aspect of the present disclosure, the non-aqueous electrolyte further includes lithium salt.

According to the batteries provided in the second aspect, the third aspect, and the fourth aspect of the present disclosure, the lithium salt is selected from at least one of lithium bis(trifluoromethanesulfonyl)imide, lithium bis(fluorosulfonyl)imide, or lithium hexafluorophosphate (LiPF₆), and preferably, is lithium hexafluorophosphate (LiPF₆).

According to the batteries provided in the second aspect, the third aspect, and the fourth aspect of the present disclosure, the lithium salt accounts for 13-20 wt % of a total mass of the non-aqueous electrolyte solution, for example, is 13 wt %, 14 wt %, 15 wt %, 16 wt %, 17 wt %, 18 wt %, 19 wt %, 20 wt %, or a point value in a range formed by any two of the foregoing values.

According to the batteries provided in the second aspect, the third aspect, and the fourth aspect of the present disclosure, the battery is, for example, a lithium-ion battery.

According to the batteries provided in the second aspect, the third aspect, and the fourth aspect of the present disclosure, the positive electrode plate includes a positive electrode current collector and a positive electrode active material layer coated on a surface of at least one side of the positive electrode current collector.

Preferably, the positive electrode active material layer includes a positive electrode active material, a conductive agent, and a binder.

According to an exemplary implementation of the battery provided in the second aspect of the present disclosure, a mass ratio of the positive electrode active material, the conductive agent, and the binder is 97.0:1.0:2.0. According to an exemplary implementation of the battery provided in the third aspect of the present disclosure, a mass ratio of the positive electrode active material, the conductive agent, and the binder is 97.6:1.1:1.3. According to an exemplary implementation of the battery provided in the fourth aspect of the present disclosure, a mass ratio of the positive electrode active material, the conductive agent, and the binder is 98.2:1.0:0.8.

According to the batteries provided in the second aspect, the third aspect, and the fourth aspect of the present disclosure, the positive electrode active material is selected from lithium cobalt (LiCoO₂) or lithium cobalt (LiCoO₂) doped and coated with two or more elements in Al, Mg, Mn, Cr, Ti, or Zr. A chemical formula of lithium cobalt (LiCoO₂) doped and coated with two or more elements in Al, Mg, Mn, Cr, Ti, or Zr is LiₓCo_{1-y1-y2-y3-y4}A_{y1}B_{y2}C_{y3}D_{y4}O₂, where 0.95≤x≤1.05, 0.01≤y1≤0.1, 0.01≤y2≤0.1, 0≤y3≤0.1, 0≤y4≤0.1, and A, B, C, and D are selected from two or more elements in Al, Mg, Mn, Cr, Ti, or Zr.

According to the batteries provided in the second aspect, the third aspect, and the fourth aspect of the present disclosure, a median particle diameter Dv50 of lithium cobalt doped and coated with two or more elements in Al, Mg, Mn, Cr, Ti, or Zr ranges from 10 μm to 17 μm, and a specific surface area BET ranges from 0.15 m²/g to 0.45 m²/g.

According to the battery provided in the second aspect of the present disclosure, the conductive agent in the positive electrode active material layer is selected from at least one of acetylene black, carbon nanotube, Super-P, ketjen black, or vapor-grown carbon fiber. According to the batteries provided in the third aspect and the fourth aspect of the present disclosure, the conductive agent in the positive electrode active material layer is selected from acetylene black.

According to the battery provided in the second aspect of the present disclosure, the binder in the positive electrode active material layer is selected from at least one of polyvinylidene fluoride (PVDF) or polyvinylpyrrolidone (PVP). According to the batteries provided in the third aspect and the fourth aspect of the present disclosure, the binder in the positive electrode active material layer is selected from polyvinylidene fluoride (PVDF).

According to the batteries provided in the second aspect, the third aspect, and the fourth aspect of the present disclosure, the negative electrode plate includes a negative electrode current collector and a negative electrode active material layer coated on a surface of either or both sides of the negative electrode current collector, and the negative electrode active material layer includes a negative electrode active material, a conductive agent, and a binder.

According to the batteries provided in the second aspect, the third aspect, and the fourth aspect of the present disclosure, the negative electrode active material is selected from graphite.

According to the batteries provided in the second aspect, the third aspect, and the fourth aspect of the present disclosure, the negative electrode active material further optionally includes SiOₓ/C or Si/C, where 0<x<2. For example, the negative electrode active material further includes 1-12 wt % SiOₓ/C, for example, the content is 1 wt %, 2 wt %, 5 wt %, 8 wt %, 10 wt %, 12 wt %, or a point value in a range formed by any two of the foregoing values.

According to the batteries provided in the second aspect, the third aspect, and the fourth aspect of the present disclosure, a charging cut-off voltage of the batteries is 4.45V or higher.

Beneficial Effects of the present disclosure are as follows.

Firstly, according to the separator provided in the present disclosure, a battery prepared by the combination with a positive electrode material and a negative electrode material, based on a synergistic effect between a separator and an electrolyte solution, which can effectively improve safety performance of a battery cell and also take into account low-temperature performance of the battery cell.

Secondly, in a safety separator of the present disclosure, an adhesive force between an adhesive layer and positive and negative electrodes is greater than a peel force between a heat-resistant layer and a substrate, and the heat-resistant layer may withstand a high temperature of 200° C. or more. According to the separator of the present disclosure, an adhesive force between the adhesive layer and the negative electrode, and a peel force between the heat-resistant layer and the substrate are controlled in a specific ratio range, so that the heat-resistant layer and the adhesive layer are bonded to a surface of the negative electrode plate, so that a short circuit does not occur between the positive and negative electrodes at a high temperature, thereby improving safety performance of a battery, avoiding fire caused by a short circuit between the positive and negative electrodes of a battery cell, and further achieving effect of improving the safety performance of the battery.

Thirdly, according to the batteries provided in the three different aspects of the present disclosure, a non-aqueous electrolyte solution that is used includes a non-aqueous organic solvent and an additive, and an appropriate amount of ethyl propionate is added into the electrolyte solution, which may properly swell a heat-resistant layer and an adhesive layer of a separator. In this way, positive and negative electrodes of a battery cell have a better interface, so as to reduce damage and recombination of a positive electrode electrolyte interfacial film (CEI film), thereby improving stability of a positive electrode material at a high temperature and high voltage, reducing a solvent viscosity to improve electrolyte infiltration and an ionic conductivity, and further improving low temperature performance of the battery cell. In addition, an adhesive force between the adhesive layer and the negative electrode, and a peel force between the heat-resistant layer and the substrate are controlled in a specific ratio range, so that the adhesive layer and the heat-resistant layer is properly swollen in a specific content of ethyl propionate. The heat-resistant layer and the adhesive layer may be removable from a separator substrate, and bonded to a surface of the negative electrode plate, so that a short circuit does not occur between the positive and negative electrodes at a high temperature, thereby improving safety performance of a battery, avoiding fire caused by a short circuit between the positive and negative electrodes of a battery cell, and further achieving effect of improving the safety performance of the battery.

Fourthly, according to the battery provided in the third aspect of the present disclosure, a non-aqueous electrolyte solution that is used includes a non-aqueous organic solvent and an additive. Based on a synergistic effect of the additive and the non-aqueous organic solvent, a battery cell can have both long-time cycling and low temperature performance. In the non-aqueous electrolyte solution, in addition to adding a proper amount of ethyl propionate for improving low-temperature performance of a battery cell, a carbonate compound is also added as an additive, and the carbonate compound may be cross-linked on a negative electrode surface to form a relatively thick and stable solid electrolyte interphase film (SEI protective film), so as to prevent the electrolyte solution from being reduced on the negative electrode surface, thereby reducing heat release of side reaction.

Lastly, the battery provided in the fourth aspect of the present disclosure, a non-aqueous electrolyte solution that is used includes a non-aqueous organic solvent and an additive. Based on a synergistic effect of the additive and the non-aqueous organic solvent, a battery cell can take into account high and low temperature performance. In the non-aqueous electrolyte solution, in addition to adding a proper amount of ethyl propionate for improving low-temperature performance of a battery cell, a compound containing nitrile functional groups is also added as an additive, where the compound containing nitrile functional groups may be cross-linked on a positive electrode surface to form a relatively thick and stable CEI protective film, so as to prevent the electrolyte solution from being oxidized on the surface of the positive electrode, thereby reducing heat release of side reaction.

### BRIEF DESCRIPTION OF THE DRAWINGS

FIG. 1 is a schematic diagram of a partial cross-section of a lithium-ion battery according to the present disclosure.

### DETAILED DESCRIPTION OF THE EMBODIMENTS

The present disclosure is further described in detail below with reference to specific embodiments. It should be understood that the following embodiments are merely used to illustrate and explain the present disclosure, and shall not be construed as limitation to the protection scope of the present disclosure. All technologies implemented based on the foregoing content of the present disclosure shall fall within the protection scope of the present disclosure.

Unless otherwise stated, raw materials and reagents used in the following embodiments are commercially available commodities, or may be prepared by a known method.

Comparative Examples 1 and 2 and Examples 1-8

Lithium-ion batteries in Comparative examples 1 and 2 and Examples 1-8 were prepared according to the following preparation method, and a difference lies only in that different separators and electrolyte solutions were selected. The difference is specifically shown in Table 1-1 and Table 1-2.

(1) Preparation of a Positive Electrode Plate

A positive electrode active material LiCoO₂, a binder polyvinylidene fluoride (PVDF), and a conductive agent acetylene black were mixed at a weight ratio of 97:1.0:2.0, added with N-methylpyrrolidone (NMP). The mixture was stirred under action of a vacuum mixer until a mixed system became a positive electrode slurry with uniform fluidity. The positive electrode slurry was evenly applied on aluminum foil having a thickness of 11 μm. The coated aluminum foil was baked in a five-stage oven with different temperatures and then dried in an oven at 120° C. for 8 hours, followed by rolling and cutting, to obtain the required positive electrode plate.

(2) Preparation of a Negative Electrode Plate

A negative electrode material artificial graphite with a mass percentage of 97%, a conductive agent single-walled carbon nanotube (SWCNT) with a mass percentage of 0.2%, a conductive agent conductive carbon black (SP) with a mass percentage of 0.9%, a binder sodium carboxymethyl cellulose (CMC) with a mass percentage of 0.9%, and a binder styrene-butadiene rubber (SBR) with a mass percentage of 1.0% were made into a slurry by using a wet process. The slurry was applied on a surface of a negative electrode current collector with copper foil having a thickness of 6 μm, and then drying (temperature: 85° C., time: 5 hours), rolling and die cutting were carried out to obtain the negative electrode plate.

(3) Preparation of a Non-Aqueous Electrolyte Solution

In a glove box filled with argon (moisture<10 ppm, oxygen<1 ppm), ethylene carbonate (EC), propylene carbonate (PC), and propyl propionate (PP) were evenly mixed at a mass ratio of 1:1:3, and LiPF₆ accounting for 14 wt % of a total mass of the non-aqueous electrolyte solution and ethyl propionate (specific amounts of ethyl propionate are shown in Table 1) accounting for 10-40 wt % of the total mass of the non-aqueous electrolyte solution were slowly added into the mixed solution. The mixture was stirred evenly to obtain the non-aqueous electrolyte solution.

(4) Preparation of a Separator

Ceramic and DMAC were mixed with a solid content of 20% and stirred for 30 minutes at a speed of 1500 rpm, and the mixture was recorded as solution M1.

A binder and DMAC were mixed with a solid content of 10% and stirred for 60 minutes at a speed of 1500 rpm, and the mixture was recorded as solution N1.

A heat-resistant polymer and DMAC were mixed with a solid content of 5% and stirred for 240 minutes at a speed of 1500 rpm, and the mixture was recorded as solution L1.

The solutions M1, N1, and L1, and DMAC were mixed according to a specific proportion to obtain a mixed solution with a solid content of 6%. The mixed solution was applied on two sides of a separator PE substrate having a thickness of 5 μm by using a gravure roller. After being watered and then dried, a separator C with two sides each having a thickness of 2 μm was obtained, and the two sides of the separator C each were coated with an adhesive layer having a thickness of 1 μm.

For a ceramic type, a binder type, a heat-resistant polymer type, an adhesive polymer type used in the adhesive layer, and proportions of ceramic, binder, and heat-resistant polymer in the heat-resistant layer, refer to Table 1-1 and Table 1-2. An adhesive force between the prepared separator adhesive layer and the negative electrode is A, a peel force between the heat-resistant layer and the substrate is B, and a ratio of A to B is shown in Table 1-1 and Table 1-2.

(5) Preparation of a Lithium-Ion Battery

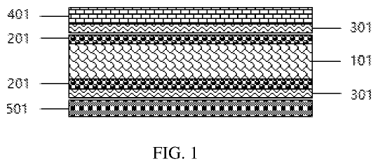

The prepared positive electrode plate, separator, and negative electrode plate were wound to obtain an unfilled bare cell. The bare cell was placed in outer packaging foil, the prepared electrolyte solution was injected into the dried bare cell, and after processes such as vacuum packaging, standing, forming, shaping, and sorting, the lithium-ion battery required was obtained. FIG. 1 is a schematic diagram of a partial cross-section of the lithium-ion battery, where 101 is a substrate; 201 is a heat-resistant layer; 301 is an adhesive layer; 401 is negative electrode; and 501 is positive electrode.

TABLE 1-1
Lithium-ion batteries prepared in Comparative Example 1 and 2 and Examples 1-8

| | Ceramic | Heat-resistant | | |
|---|---|---|---|---|
| | type | polymer | Adhesive Polymer | Binder type |
| Comparative | Aluminum | / | Polyvinylidene fluoride- | Polymethyl |
| Example 1 | oxide | | hexafluoropropylene | methacrylate |
| Comparative | Aluminum | / | Polyvinylidene fluoride- | Polymethyl |
| Example 2 | oxide | | hexafluoropropylene | methacrylate |
| Example 1 | Boron | Aramid resin | Polyvinylidene fluoride- | Polymethyl |
| | nitride | | hexafluoropropylene | methacrylate |
| Example 2 | Boron | Aramid resin | Polyvinylidene fluoride- | Polymethyl |
| | nitride | | hexafluoropropylene | methacrylate |
| Example 3 | Aluminum | Polyamide | Polyvinylidene fluoride- | Polymethyl |
| | oxide | | hexafluoropropylene | methacrylate |
| Example 4 | Aluminum | Polyamide | Polyvinylidene fluoride- | Polymethyl |
| | oxide | | hexafluoropropylene | methacrylate |
| Example 5 | Aluminum | Polyimide | Polymethyl methacrylate | Carboxymethyl |
| | oxide | | | cellulose |
| Example 6 | Boehmite | Polyimide | Polymethyl methacrylate | Carboxymethyl |
| | | | | cellulose |
| Example 7 | Boehmite | Polyborodiphenyl- | Polyvinylidene fluoride- | Polymethyl |
| | | siloxane | hexafluoropropylene | methacrylate |
| Example 8 | Boehmite | Polyborodiphenyl- | Polyvinylidene fluoride- | Polymethyl |
| | | siloxane | hexafluoropropylene | methacrylate |

### Comparative Examples 3-7 and Examples 9-16

TABLE 1-2
Lithium-ion batteries prepared in Comparative
Example 1 and 2 and Examples 1-8

| | | | Heat- | | |
|---|---|---|---|---|---|
| | | Heat | resistant | Added | |
| | Ratio of | shrinkage | layer content | amount | |
| | Ceramic/heat- | of heat- | on the | of ethyl | |
| | resistant | resistant | electrode | propi- | |
| | polymer/binder | layer | plate | onate | A/B |
| Comparative | 96/0/4 | 6.3% | 20% | 0% | 0.2 |
| Example 1 | | | | | |
| Comparative | 96/0/4 | 6.3% | 20% | 15% | 0.2 |
| Example 2 | | | | | |
| Example 1 | 10/89/1 | 0.5% | 95% | 15% | 6.4 |
| Example 2 | 10/89/1 | 0.5% | 95% | 0% | 6 |
| Example 3 | 20/78/2 | 1.5% | 85% | 25% | 4.8 |
| Example 4 | 10/88/2 | 1.5% | 85% | 50% | 5.3 |
| Example 5 | 20/76/4 | 2.5% | 70% | 15% | 2.7 |
| Example 6 | 20/76/4 | 2.5% | 70% | 30% | 3.3 |
| Example 7 | 15/83.5/1.5 | 1% | 80% | 20% | 6.2 |
| Example 8 | 15/83.5/1.5 | 1% | 80% | 40% | 6.5 |

Note:
“/” indicates that no material is added.

Lithium-ion batteries in Comparative examples 3-7 and Examples 9-16 were prepared according to the following preparation method, and a difference lies only in that different separators and electrolyte solutions were selected. The difference is specifically shown in Table 2.

(1) Preparation of a Positive Electrode Plate

A positive electrode active material LiCoO₂, a binder polyvinylidene fluoride (PVDF), and a conductive agent acetylene black were mixed at a weight ratio of 97.6:1.1:1.3, added with N-methylpyrrolidone (NMP). The mixture was stirred under action of a vacuum mixer until a mixed system became a positive electrode slurry with uniform fluidity. The positive electrode slurry was evenly applied on aluminum foil having a thickness of 11 μm. The coated aluminum foil was baked in a five-stage oven with different temperatures and then dried in an oven at 120° C. for 8 hours, followed by rolling and cutting, to obtain the required positive electrode plate.

(2) Preparation of a Negative Electrode Plate

A negative electrode material artificial graphite with a mass percentage of 97.4%, a conductive agent single-walled carbon nanotube (SWCNT) with a mass percentage of 0.1%, a conductive agent conductive carbon black (SP) with a mass percentage of 0.6%, a binder sodium carboxymethyl cellulose (CMC) with a mass percentage of 0.9%, and a binder styrene-butadiene rubber (SBR) with a mass percentage of 1.0% were made into a slurry by using a wet process. The slurry was applied on a surface of a negative electrode current collector with copper foil having a thickness of 6 μm, and then drying (temperature: 85° C., time: 5 hours), rolling and die cutting were carried out to obtain the negative electrode plate.

(3) Preparation of a Non-Aqueous Electrolyte Solution

In a glove box filled with argon (moisture<10 ppm, oxygen<1 ppm), ethylene carbonate (EC), propylene carbonate (PC), and propyl propionate (PP) were evenly mixed at a mass ratio of 1:1:1, and LiPF₆ accounting for 14 wt % of a total mass of the non-aqueous electrolyte solution, ethyl propionate (specific amounts of ethyl propionate are shown in Table 2) accounting for 10-40 wt % of the total mass of the non-aqueous electrolyte solution, and an additive (specific amounts and types of additives are shown in Table 2) were slowly added into the mixed solution. The mixture was stirred evenly to obtain the non-aqueous electrolyte solution.

(4) Preparation of a Separator

Ceramic and N, N-dimethylacetamide were mixed with a solid content of 20% and stirred for 30 minutes at a speed of 1500 rpm, and the mixture was recorded as solution M2.

A binder and N, N-dimethylacetamide were mixed with a solid content of 10% and stirred for 60 minutes at a speed of 1500 rpm, and the mixture was recorded as solution N2.

A heat-resistant polymer and N, N-dimethylacetamide were mixed with a solid content of 5% and stirred for 240 minutes at a speed of 1500 rpm, and the mixture was recorded as solution L2.

The solution M2, N2, L2, and N, N-dimethylacetamide were mixed according to a specific proportion to obtain a mixed solution with a solid content of 6%. The mixed solution was applied on two sides of a separator polyethylene substrate having a thickness of 5 μm by using a gravure roller. After being watered and then dried, a separator C with two sides each having a thickness of 2 μm was obtained, and the two sides of the separator C each were coated with an adhesive layer having a thickness of 1 μm. The ceramic is aluminum oxide, the binder is PVDF-HFP, the heat-resistant polymer is aramid resin, and an adhesive polymer used in the adhesive layer is polymethyl methacrylate. A ratio of the ceramic and the heat-resistant polymer in the heat-resistant layer is 1:9, and a proportion of the binder in the heat-resistant layer is shown in Table 2. An adhesive force between the prepared separator adhesive layer and the negative electrode is A, a peel force between the heat-resistant layer and the substrate is B, and a ratio of A to B is shown in Table 2.

(5) Preparation of a Lithium-Ion Battery

The foregoing prepared positive electrode plate, separator, and negative electrode plate were wound to obtain an unfilled bare cell. The bare cell was placed in an outer packaging foil, the prepared electrolyte solution was injected into the dried bare cell, and after processes such as vacuum packaging, standing, forming, shaping, and sorting, the lithium-ion battery required was obtained.

TABLE 2
Lithium-ion batteries prepared in Comparative Examples 3-7 and Examples 9-16

| | | | | Ratio of A to B (in the |
|---|---|---|---|---|
| | | | | separator, an adhesive |
| | | Proportion of | | force between the |
| | | ethyl propionate | | adhesive layer and |
| | | in total mass of | Proportion of | negative electrode is A, |
| | Carbonate | non-aqueous | binder in heat- | and a peel force between |
| | compound | electrolyte | resistant | the heat-resistant layer |
| Item | (additive) | solution (%) | layer (%) | and the substrate is B) |
| Comparative | 5% fluoroethylene | 0.0% | 1% | 0.5 |
| Example 3 | carbonate | | | |
| Comparative | 5% fluoroethylene | 0.0% | 2% | 2.5 |
| Example 4 | carbonate | | | |
| Comparative | 5% fluoroethylene | 20.0% | 1% | 0.5 |
| Example 5 | carbonate | | | |
| Comparative | / | 20.0% | 1% | 0.5 |
| Example 6 | | | | |
| Comparative | / | 20.0% | 2% | 2.5 |
| Example 7 | | | | |
| Example 9 | 5% fluoroethylene | 20.0% | 2% | 2.5 |
| | carbonate | | | |
| Example 10 | 8% fluoroethylene | 15.0% | 4% | 1.5 |
| | carbonate | | | |
| Example 11 | 7% fluoroethylene | 25.0% | 1.5% | 2.0 |
| | carbonate | | | |
| Example 12 | 9% fluoroethylene | 10.0% | 8% | 5.0 |
| | carbonate | | | |
| Example 13 | 6% fluoroethylene | 28.0% | 20% | 6.0 |
| | carbonate and 0.5% | | | |
| | vinylene carbonate | | | |
| Example 14 | 10% fluoroethylene | 35.0% | 10% | 4.5 |
| | carbonate | | | |
| Example 15 | 7% fluoroethylene | 40.0% | 5% | 3.5 |
| | carbonate and 0.8% | | | |
| | vinyl ethylene | | | |
| | carbonate | | | |
| Example 16 | 4% fluoroethylene | 18.0% | 6% | 3.0 |
| | carbonate and 1% | | | |
| | vinylethylene | | | |
| | carbonate | | | |

Note:
“/” indicates that such material is not added.

### Comparative Examples 8-12 and Examples 17-24

Lithium-ion batteries in Comparative examples 8-12 and Examples 17-24 were prepared according to the following preparation method, and a difference lies only in that different separators and electrolyte solutions were selected. The difference is specifically shown in Table 3.

(1) Preparation of a Positive Electrode Plate

A positive electrode active material LiCoO₂, a binder polyvinylidene fluoride (PVDF), and a conductive agent acetylene black were mixed at a weight ratio of 98.2:1.0:0.8, added with N-methylpyrrolidone (NMP). The mixture was stirred under action of a vacuum mixer until a mixed system became a positive electrode slurry with uniform fluidity. The positive electrode slurry was evenly applied on aluminum foil having a thickness of 10 μm. The coated aluminum foil was baked in a five-stage oven with different temperatures and then dried in an oven at 120° C. for 8 hours, followed by rolling and cutting, to obtain the required positive electrode plate.

(2) Preparation of a Negative Electrode Plate

A negative electrode material artificial graphite with a mass percentage of 96.9%, a conductive agent single-walled carbon nanotube (SWCNT) with a mass percentage of 0.1%, a conductive agent conductive carbon black (SP) with a mass percentage of 1%, a binder sodium carboxymethyl cellulose (CMC) with a mass percentage of 1.0%, and a binder styrene-butadiene rubber (SBR) with a mass percentage of 1.0% were made into a slurry by using a wet process. The slurry was applied on a surface of a negative electrode current collector with copper foil having a thickness of 6 μm, and then drying (temperature: 85° C., time: 5 hours), rolling and die cutting were carried out to obtain the negative electrode plate.

(3) Preparation of a Non-Aqueous Electrolyte Solution

In a glove box filled with argon (moisture<10 ppm, oxygen<1 ppm), ethylene carbonate (EC), propylene carbonate (PC), and propyl propionate (PP) were evenly mixed at a mass ratio of 2:1:2, and LiPF₆ accounting for 14 wt % of a total mass of the non-aqueous electrolyte solution, ethyl propionate (specific amounts of ethyl propionate are shown in Table 3) accounting for 10-40 wt % of the total mass of the non-aqueous electrolyte solution, and an additive (specific amounts and types of additives are shown in Table 3) were slowly added into the mixed solution. The mixture was stirred evenly to obtain the non-aqueous electrolyte solution.

(4) Preparation of a Separator

Ceramic and N, N-dimethylacetamide were mixed with a solid content of 20% and stirred for 30 minutes at a speed of 1500 rpm, and the mixture was recorded as solution M3.

A binder and N, N-dimethylacetamide were mixed with a solid content of 10% and stirred for 60 minutes at a speed of 1500 rpm, and the mixture was recorded as solution N3.

A heat-resistant polymer and N, N-dimethylacetamide were mixed with a solid content of 5% and stirred for 240 minutes at a speed of 1500 rpm, and the mixture was recorded as solution L3.

The solution M3, N3, L3, and N, N-dimethylacetamide were mixed according to a specific proportion to obtain a mixed solution with a solid content of 6%. The mixed solution was applied on two sides of a separator polyethylene substrate having a thickness of 5 μm by using a gravure roller. After being watered and then dried, a separator C with two sides each having a thickness of 2 μm was obtained, and the two sides of the separator C each were coated with an adhesive layer having a thickness of 1 μm. The ceramic is aluminum oxide, the binder is PVDF-HFP, the heat-resistant polymer is aramid resin, and an adhesive polymer used in the adhesive layer is polymethyl methacrylate. A ratio of the ceramic and the heat-resistant polymer in the heat-resistant layer is 1:9, and a proportion of the binder in the heat-resistant layer is shown in Table 3. An adhesive force between the prepared separator adhesive layer and the negative electrode is A, a peel force between the heat-resistant layer and the substrate is B, and a ratio of A to B is shown in Table 3.

(5) Preparation of a Lithium-Ion Battery

The foregoing prepared positive electrode plate, separator, and negative electrode plate were wound to obtain an unfilled bare cell. The bare cell was placed in an outer packaging foil, the prepared electrolyte solution was injected into the dried bare cell, and after processes such as vacuum packaging, standing, forming, shaping, and sorting, the lithium-ion battery required was obtained.

TABLE 3
Lithium-ion batteries prepared in Comparative Examples 8-12 and Examples 17-24

| | | | | Ratio of A to B (in the |
|---|---|---|---|---|
| | | | | separator, an adhesive |
| | | Proportion of | | force between the |
| | | ethyl propionate | | adhesive layer and the |
| | | in total mass of | Proportion of | negative electrode is A, |
| | Compound containing | non-aqueous | binder in heat- | and a peel force between |
| | nitrile functional | electrolyte | resistant | the heat-resistant layer |
| Item | groups (additive) | solution (%) | layer (%) | and the substrate is B) |
| Comparative | 3% 1,3,6- | 0.0% | 0.5% | 0.7 |
| Example 9 | hexanetricarbonitrile | | | |
| Comparative | 3% 1,3,6- | 0.0% | 2% | 3 |
| Example 9 | hexanetricarbonitrile | | | |
| Comparative | 3% 1,3,6- | 15.0% | 0.5% | 0.7 |
| Example 10 | hexanetricarbonitrile | | | |
| Comparative | / | 15.0% | 0.5% | 0.7 |
| Example 11 | | | | |
| Comparative | / | 15.0% | 2% | 3 |
| Example 12 | | | | |
| Example 17 | 3% 1,3,6- | 15.0% | 2% | 3 |
| | hexanetricarbonitrile | | | |
| Example 18 | 3.5% adiponitrile | 20.0% | 1.5% | 1.5 |
| Example 19 | 2% succinonitrile and | 25.0% | 4% | 2.0 |
| | 1.5% adiponitrile | | | |
| Example 20 | 1% succinonitrile | 10.0% | 20% | 5.0 |
| Example 21 | 4% ethylene glycol | 28.0% | 6% | 2.5 |
| | bis(2-cyanoethyl) | | | |
| | ether | | | |
| Example 22 | 3% glycerol trinitrile | 35.0% | 10% | 4.5 |
| | and 2.5% succinonitrile | | | |
| Example 23 | 5% succinonitrile and | 40.0% | 5% | 3.5 |
| | 5% adiponitrile | | | |
| Example 24 | 2% 1,3,6-hexane- | 18.0% | 8% | 3.0 |
| | tricarbonitrile and | | | |
| | 2.5% adiponitrile | | | |

Note:
“/” indicates that such material is not added.

For the batteries, a test for heat resistance of a heat-resistant layer, a test for a thickness of a separator after dissection, and tests for an adhesive force, a peel force, and electrochemical performance were carried out. Details are as follows.

In the test for heat resistance of a heat-resistant layer, heat-resistant layers of separators in Comparative Examples 1-12 and Examples 1-24 were baked in an oven at (150±2°) C for 1 hour. A size of a separator before baking is recorded as L1, a size of the separator after baking is recorded as L2 (the size of a separator means a length of the separator in an Machine Direction (MD) or Transverse Direction (TD)), and then heat shrinkage of the separator is (L1−L2)/L1. Test results for Comparative Examples 1 and 2 and Examples 1-8 are shown in Table 1-1 and Table 1-2, test results for Comparative Examples 3-7 and Examples 9-16 are shown in Table 5-1 and Table 5-2, and test results for Comparative Examples 8-12 and Examples 17-24 are shown in Table 6-1 and Table 6-2.

In the test for a thickness of a separator after dissection, batteries in Comparative Examples 1-12 and Examples 1-24 were charged at a constant current of 0.7C, and a cut-off current was 0.05C. The batteries were left aside for 5 minutes after being fully charged, and then dissected, and a thickness test was performed on dissected separators. A thickness of a separator at a position in contact with an electrode plate is T1, a thickness of a separator at a position not in contact with the electrode plate is T2, a thickness of a substrate is T, and a content of a heat-resistant layer on the electrode plate (a residual amount of the heat-resistant layer of the electrode plate) is (T2−T1)/(T2−T). Test results for Comparative Examples 1 and 2 and Examples 1-8 are shown in Table 1-1 and Table 1-2, test results for Comparative Examples 3-7 and Examples 9-16 are shown in Table 5-1 and Table 5-2, and test results for Comparative Examples 8-12 and Examples 17-24 are shown in Table 6-1 and Table 6-2.

In the test for adhesive performance, batteries in Comparative Examples 1-12 and Examples 1-24 were charged at a constant current of 0.7C, and a cut-off current was 0.05C. The batteries were left aside for 5 minutes after being fully charged, and then dissected. A negative electrode sample with a size of 40 mm in length*18 mm in width was selected along a direction of a tab, and a 3M single-sided adhesive tape with a size of 15 mm*100 mm was attached to the negative electrode sample. The 3M single-sided adhesive tape and a negative electrode plate at an included angle of 180 degrees were tested on a universal testing machine at a speed of 100 mm/min and a test displacement of 50 mm. A test result is recorded as an adhesive force A (unit: N/m) between a separator adhesive layer and a negative electrode.

In the test for a peel force, a steel plate with a size of 40 mm*150 mm was selected, and a 3M double-sided adhesive tape with a size of 18 mm*100 mm was attached to the steel plate. Then, a back face of a tested surface of a separator in Comparative Examples 1-12 and Examples 1-24 was attached to the 3M double-sided adhesive tape, and a 3M double-sided adhesive tape with a size of 15 mm*150 mm was attached to the tested surface of the separator. The 3M adhesive tape and the separator at an included angle of 180 degrees were tested on a universal testing machine at a speed of 100 mm/min and a test displacement of 50 mm. A test result is a peel force B (unit: N/m) between a separator heat-resistant layer and a substrate layer.

A value of A/B is calculated based on the value of A obtained in the test for adhesive performance and the value of B obtained in the test for a peel force. Test results for Comparative Examples 1 and 2 and Examples 1-8 are shown in Table 1-1 and Table 1-2, test results for Comparative Examples 3-7 and Examples 9-16 are shown in Table 2, and test results for Comparative Examples 8-12 and Examples 17-24 are shown in Table 3.

In a cycling test at 25° C., the batteries in Comparative Examples 1-7 and Examples 1-16 were placed in an environment of (25±2°) C for 2-3 hours. When bodies of the batteries reached a temperature of (25±2°) C, the batteries were charged at a constant current of 0.7C, and a cut-off current was 0.05C. The batteries were left aside for 5 minutes after being fully charged, and then discharged at a constant current of 0.5C to a cut-off voltage of 3.0 V. The highest discharge capacity in the first three cycles was recorded as an initial capacity Q. When a number of cycles reached 1000, the last discharge capacity Q₁ of the battery was recorded.

Battery capacity retention rate (%)=Q₁/Q×100%. Test results for Comparative Examples 1 and 2 and Examples 1-8 are shown in Table 4, and test results for Comparative Examples 3-7 and Examples 9-16 are shown in Table 5-1 and Table 5-2.

In a cycling test at 55° C., the batteries prepared in Comparative Examples 8-12 and Examples 17-24 were placed in an environment of (55±2°) C. After 2-3 hours, when bodies of the batteries reached a temperature of (55±2°) C, the batteries were charged at a constant current of 0.7C, and a cut-off current was 0.05C. The batteries were left aside for 5 minutes after being fully charged, and then discharged at a constant current of 0.5C to a cut-off voltage of 3.0 V. The highest discharge capacity in the first three cycles was recorded as an initial capacity Q. When a number of cycles reached 300, the last discharge capacity Q₁ of the battery was recorded.

Battery capacity retention rate (%)=Q₁/Q×100%. The test results are shown in Table 6-1 and Table 6-2.

In a low temperature discharge test at −20° C., batteries prepared in Comparative Examples 1 and 2, Comparative Examples 8-12, Examples 1-8, and Examples 17-24 were first discharged at 0.2C to 3.0 V at ambient temperature of (25±3°) C, and left aside for 5 minutes. Then the batteries were charged at 0.7C, and when a voltage at cell terminals reached a charging limit voltage, the batteries began to be charged at a constant voltage instead. The charging was not stopped until a charging current was less than or equal to a cut-off current. The batteries were left aside for 5 minutes and then discharged at 0.2C to 3.0 V, and a discharge capacity in this case was recorded as a normal-temperature capacity Q₂. Then cells were charged at 0.7C, and when a voltage at the cell terminals reached the charging limit voltage, the batteries began to be charged at a constant voltage. The charging was not stopped until a charging current is less than or equal to the cut-off current. The fully charged batteries were left aside at (−20±2°) C for 4 hours, and then discharged at 0.2C to a cut-off voltage 3.0V. A discharge capacity Q₃ was recorded to calculate a low-temperature discharge capacity retention rate.

Battery low-temperature discharge capacity retention rate (%)=Q₃/Q₂×100%. Test results for Comparative Examples 1 and 2 and Examples 1-8 are shown in Table 4, and test results for Comparative Examples 8-12 and Examples 17-24 are shown in Table 6-1 and Table 6-2.

In a low temperature discharge test at −10° C., batteries prepared in Comparative Examples 3-7 and Examples 9-16 were first discharged at 0.2C to 3.0 V at ambient temperature of (25±3°) C, and left aside for 5 minutes. Then the batteries were charged at 0.7C, and when a voltage at cell terminals reached a charging limit voltage, the batteries began to be charged at a constant voltage instead. The charging was not stopped until a charging current was less than or equal to a cut-off current. The batteries were left aside for 5 minutes and then discharged at 0.2C to 3.0 V, and a discharge capacity in this case was recorded as a normal-temperature capacity Q₄. Then cells were charged at 0.7C, and when a voltage at the cell terminals reached the charging limit voltage, the batteries began to be charged at a constant voltage. The charging was not stopped until a charging current is less than or equal to the cut-off current. The fully charged batteries were left aside at (−10±2°) C for 4 hours, and then discharged at 0.2C to a cut-off voltage 3.0V. A discharge capacity Q₅ was recorded to calculate a low-temperature discharge capacity retention rate.

Battery low-temperature discharge capacity retention rate (%)=Q₅/Q₄×100%. The test results are shown in Table 5-1 and Table 5-2.

In a thermal shock test at 150° C., the batteries prepared in Comparative Examples 1-12 and Examples 1-24 were heated in a convection mode or by using a circulation hot air box at a start temperature of (25±3°) C, with a temperature change rate of (5±2°) C/min. The temperature was raised to (150±2°) C, the batteries were kept in the temperature for 60 minutes, and then the test ended. Test results for Comparative Examples 1 and 2 and Examples 1-8 are shown in Table 4, test results for Comparative Examples 3-7 and Examples 9-16 are shown in Table 5-1 and Table 5-2, and test results for Comparative Examples 8-12 and Examples 17-24 are shown in Table 6-1 and Table 6-2.

In an over-charge test, the batteries obtained in Comparative Examples 1-12 and Examples 1-24 were charged to 5 V at a constant current of 3C rate, and states of the batteries were recorded. Test results for Comparative Examples 1 and 2 and Examples 1-8 are shown in Table 4, test results for Comparative Examples 3-7 and Examples 9-16 are shown in Table 5-1 and Table 5-2, and test results for Comparative Examples 8-12 and Examples 17-24 are shown in Table 6-1 and Table 6-2.

In a nail penetration test, a high-temperature resistant steel needle (a cone angle of the needle tip ranges from 45°-60 , and a surface of the needle is smooth without rust, oxide layer, or grease) with a diameter of Φ ranging from 5 mm to 8 mm penetrated through the batteries obtained in Comparative Examples 1-12 and Examples 1-24 from a direction perpendicular to plates of the batteries at a speed of (25±5) mm/s, and a piercing position was preferably close to a geometric center of a pierced surface (the steel needle remained in the batteries). Based on observation, after 1 hour or when a maximum temperature of surfaces of the batteries dropped to 10° C. or below, the test ended. Test results for Comparative Examples 1 and 2 and Examples 1-8 are shown in Table 4, test results for Comparative Examples 3-7 and Examples 9-16 are shown in Table 5-1 and Table 5-2, and test results for Comparative Examples 8-12 and Examples 17-24 are shown in Table 6-1 and Table 6-2.

TABLE 4
Experimental test results of batteries obtained
in Comparative Examples 1 and 2 and Examples 1-8

| | | | 150° C./60 min | | |
|---|---|---|---|---|---|
| | Capacity | Capacity | furnace | | |
| | retention rate | retention rate | temperature | Overcharge | Acupuncture |
| | (%) after | (%) after | (ignition state: | (ignition status: | (ignition status: |
| | 1000 cycles | discharge | number of | number of | number of |
| | at 0.7 C | at 0.2 C | passed/number | passed/number | passed/number |
| | and 25° C. | and −20° C. | of tested) | of tested) | of tested) |
| Comparative | 68.63% | 54.62% | 5/30 | 12/30 | 2/30 |
| Example 1 | | | | | |
| Comparative | 72.45% | 60.38% | 3/30 | 7/30 | 0/30 |
| Example 2 | | | | | |
| Example 1 | 73.05% | 61.23% | 30/30 | 30/30 | 30/30 |
| Example 2 | 69.24% | 55.40% | 30/30 | 30/30 | 30/30 |
| Example 3 | 75.32% | 64.08% | 30/30 | 30/30 | 30/30 |
| Example 4 | 80.46% | 75.60% | 30/30 | 30/30 | 30/30 |
| Example 5 | 72.88% | 60.98% | 30/30 | 30/30 | 30/30 |
| Example 6 | 75.98% | 66.82% | 30/30 | 30/30 | 30/30 |
| Example 7 | 74.05% | 62.45% | 30/30 | 30/30 | 30/30 |
| Example 8 | 77.36% | 68.53% | 30/30 | 30/30 | 30/30 |

TABLE 5-1
Experimental test results of batteries obtained in Comparative Examples 3-7 and Examples 9-16

| | | | Capacity | Capacity | Thermal shock for 60 | |
|---|---|---|---|---|---|---|
| | | Heat-resistant | retention rate | retention rate | minutes at 150° C. | |
| | Heat | layer content | (%) after | (%) after | Ignition | Explosion |
| | shrinkage of | on the | 1000 cycles | discharge | (number of | (number of |
| | heat-resistant | electrode | at 1 C | at 0.2 C | passed/number | passed/number |
| Group | layer | plate | and 25° C. | and −10° C. | of tested) | of tested) |
| Comparative | 8.5% | 13% | 64.83% | 57.12% | 1/5 | 2/5 |
| Example 3 | | | | | | |
| Comparative | 8.0% | 20% | 66.35% | 59.03% | 4/5 | 4/5 |
| Example 4 | | | | | | |
| Comparative | 7.2% | 22% | 62.46% | 65.12% | 2/5 | 2/5 |
| Example 5 | | | | | | |
| Comparative | 8.8% | 16% | 50.52% | 70.53% | 0/5 | 0/5 |
| Example 6 | | | | | | |
| Comparative | 7.5% | 21% | 48.53% | 72.43% | 4/5 | 4/5 |
| Example 7 | | | | | | |
| Example 9 | 3% | 85% | 73.89% | 73.99% | 5/5 | 5/5 |
| Example 10 | 0.9% | 90% | 75.26% | 75.25% | 5/5 | 5/5 |
| Example 11 | 2.5% | 84% | 76.21% | 81.38% | 5/5 | 5/5 |
| Example 12 | 1.8% | 88% | 80.26% | 74.28% | 5/5 | 5/5 |
| Example 13 | 2.8% | 80% | 78.25% | 80.46% | 5/5 | 5/5 |
| Example 14 | 1.6% | 89% | 82.14% | 84.54% | 5/5 | 5/5 |
| Example 15 | 4% | 72% | 80.93% | 87.17% | 5/5 | 5/5 |
| Example 16 | 0.5% | 90% | 74.19% | 77.81% | 5/5 | 5/5 |

TABLE 5-2
Experimental test results of batteries obtained
in Comparative Examples 3-7 and Examples 9-16

| | Overcharge | | Acupuncture | |
|---|---|---|---|---|
| | Ignition | Explosion | Ignition | Explosion |
| | (number of | (number of | (number of | (number of |
| | passed/number | passed/number | passed/number | passed/number |
| Group | of tested) | of tested) | of tested) | of tested) |
| Comparative | 1/5 | 2/5 | 1/5 | 2/5 |
| Example 3 | | | | |
| Comparative | 4/5 | 3/5 | 3/5 | 4/5 |
| Example 4 | | | | |
| Comparative | 2/5 | 2/5 | 3/5 | 2/5 |
| Example 5 | | | | |
| Comparative | 1/5 | 0/5 | 0/5 | 0/5 |
| Example 6 | | | | |
| Comparative | 4/5 | 3/5 | 4/5 | 3/5 |
| Example 7 | | | | |
| Example 9 | 5/5 | 5/5 | 5/5 | 5/5 |
| Example 10 | 5/5 | 5/5 | 5/5 | 5/5 |
| Example 11 | 5/5 | 5/5 | 5/5 | 5/5 |
| Example 12 | 5/5 | 5/5 | 5/5 | 5/5 |
| Example 13 | 5/5 | 5/5 | 5/5 | 5/5 |
| Example 14 | 5/5 | 5/5 | 5/5 | 5/5 |
| Example 15 | 5/5 | 5/5 | 5/5 | 5/5 |
| Example 16 | 5/5 | 5/5 | 5/5 | 5/5 |

TABLE 6-1
Experimental test results of batteries obtained in Comparative Examples 8-12 and Examples 17-24

| | | | Capacity | Capacity | Thermal shock for 60 | |
|---|---|---|---|---|---|---|
| | | | retention rate | retention rate | minutes at 150° C. | |
| | Heat | Residue of | (%) after | (%) after | Ignition | Explosion |
| | shrinkage of | heat-resistant | 300 cycles | discharge | (number of | (number of |
| | heat-resistant | layer of the | at 55° C. | at 0.2 C | passed/number | passed/number |
| Group | layer | electrode | and 0.7 C | and −20° C. | of tested) | of tested) |
| Comparative | 8.8% | 15% | 66.13% | 52.19% | 1/5 | 2/5 |
| Example 8 | | | | | | |
| Comparative | 7.6% | 20% | 68.95% | 54.07% | 4/5 | 3/5 |
| Example 9 | | | | | | |
| Comparative | 6.9% | 16% | 64.51% | 60.12% | 2/5 | 2/5 |
| Example 10 | | | | | | |
| Comparative | 6.8% | 14% | 53.54% | 65.53% | 0/5 | 0/5 |
| Example 11 | | | | | | |
| Comparative | 8.0% | 22% | 58.52% | 67.43% | 4/5 | 4/5 |
| Example 12 | | | | | | |
| Example 17 | 1% | 88% | 73.89% | 68.93% | 5/5 | 5/5 |
| Example 18 | 0.5% | 95% | 75.26% | 74.21% | 5/5 | 5/5 |
| Example 19 | 1.5% | 85% | 72.27% | 76.38% | 5/5 | 5/5 |
| Example 20 | 1.8% | 85% | 70.56% | 70.28% | 5/5 | 5/5 |
| Example 21 | 2.3% | 74% | 74.55% | 75.46% | 5/5 | 5/5 |
| Example 22 | 2.5% | 72% | 77.84% | 79.58% | 5/5 | 5/5 |
| Example 23 | 4% | 68% | 80.53% | 82.14% | 5/5 | 5/5 |
| Example 24 | 3.5% | 70% | 76.79% | 72.82% | 5/5 | 5/5 |

TABLE 6-2
Experimental test results of batteries obtained
in Comparative Examples 8-12 and Examples 17-24

| | Overcharge | | Acupuncture | |
|---|---|---|---|---|
| | Ignition | Explosion | Ignition | Explosion |
| | (number | (number | (number | (number |
| | of passed/ | of passed/ | of passed/ | of passed/ |
| | number | number | number | number |
| Group | of tested) | of tested) | of tested) | of tested) |
| Comparative | 1/5 | 2/5 | 1/5 | 2/5 |
| Example 8 | | | | |
| Comparative | 3/5 | 3/5 | 4/5 | 4/5 |
| Example 9 | | | | |
| Comparative | 2/5 | 2/5 | 3/5 | 2/5 |
| Example 10 | | | | |
| Comparative | 1/5 | 0/5 | 0/5 | 0/5 |
| Example 11 | | | | |
| Comparative | 3/5 | 3/5 | 4/5 | 4/5 |
| Example 12 | | | | |
| Example 17 | 5/5 | 5/5 | 5/5 | 5/5 |
| Example 18 | 5/5 | 5/5 | 5/5 | 5/5 |
| Example 19 | 5/5 | 5/5 | 5/5 | 5/5 |
| Example 20 | 5/5 | 5/5 | 5/5 | 5/5 |
| Example 21 | 5/5 | 5/5 | 5/5 | 5/5 |
| Example 22 | 5/5 | 5/5 | 5/5 | 5/5 |
| Example 23 | 5/5 | 5/5 | 5/5 | 5/5 |
| Example 24 | 5/5 | 5/5 | 5/5 | 5/5 |

It may be learned from the results in Table 4 that, in the present disclosure, an ethyl propionate solvent is added to an electrolyte solution, and a separator for which an adhesive force between an adhesive layer and positive and negative electrode plates is greater than a peel force between a heat-resistant layer and a substrate is used. Based on a synergistic effect of the foregoing conditions, safety performance of a lithium-ion battery can be significantly improved, and the battery have both good high temperature electrical performance and low temperature electrical performance.

It may be learned from the results in Table 5-1 and Table 5-2 that, in the present disclosure, an additive of a carbonate compound is added to an electrolyte solution, an ethyl propionate solvent is also added, and a separator for which an adhesive force between an adhesive layer and positive and negative electrode plates is greater than a peel force between a heat-resistant layer and a substrate is used. Based on a synergistic effect of the foregoing conditions, safety performance of a lithium-ion battery can be significantly improved, and the battery have both good long-time cycling and low temperature electrical performance.

It may be learned from the results in Table 6-1 and Table 6-2 that, in the present disclosure, an additive of a compound containing nitrile functional groups is added to an electrolyte solution, an ethyl propionate solvent is also added, and a separator for which an adhesive force between an adhesive layer and positive and negative electrode plates is greater than a peel force between a heat-resistant layer and a substrate is used. Based on a synergistic effect of the foregoing conditions, safety performance of a lithium-ion battery can be significantly improved, and the battery have both good high temperature electrical performance and low temperature electrical performance.

The foregoing illustrates implementation of the present disclosure. However, the present disclosure is not limited to the foregoing implementation. Any modifications, equivalent replacements, and improvements made without departing from the spirit and principle of the present disclosure shall fall within the protection scope of the present disclosure.

What is claimed is:

1. A separator used for a battery, comprising a substrate, heat-resistant layers, and an adhesive layer, wherein the heat-resistant layers are disposed on two opposite surfaces of the substrate, and the adhesive layer is disposed on the heat-resistant layer; and an adhesive force between the adhesive layer and negative electrode is A, a peel force between a heat-resistant layer and the substrate is B, and a ratio of A to B (A/B) is greater than 1.

2. The separator according to claim 1, wherein the ratio of A to B ranges from 2.5 to 6.5.

3. The separator according to claim 1, wherein a thickness of the heat-resistant layer ranges from 1 μm to 5 μm; and/or
a thickness of the adhesive layer ranges from 0.5 μm to 2 μm.

4. The separator according to claim 1, wherein a heat shrinkage of the heat-resistant layer at 150° C. for 1 hour is less than or equal to 5%.

5. The separator according to claim 1, wherein the adhesive force A between the adhesive layer and the negative electrode is greater than or equal to 10 N/m; and/or
the peel force B between the heat-resistant layer and the substrate is 5 N/m or less.

6. The separator according to claim 1, wherein the heat-resistant layer comprises a ceramic, a heat-resistant polymer, and a binder; and/or
in the heat-resistant layer, a mass proportion of the ceramic ranges from 5 wt % to 20 wt %; and/or
in the heat-resistant layer, a mass proportion of the heat-resistant polymer ranges from 60 wt % to 94 wt %; and/or
in the heat-resistant layer, a mass proportion of the binder ranges from 0.5 wt % to 20 wt %.

7. The separator according to claim 6, wherein the ceramic is selected from one, two, or more of silica, aluminum oxide, zirconium dioxide, magnesium hydroxide, boehmite, barium sulfate, fluorphlogopite, fluorapatite, mullite, cordierite, aluminum titanate, titanium dioxide, copper oxide, zinc oxide, boron nitride, aluminum nitride, magnesium nitride, or attapulgite; and/or
the heat-resistant polymer is selected from one, two, or more of polyimide, aramid resin, polyamide, polybenzimidazole, polyphenyl ester, polyborodiphenylsiloxane, polyphenylene sulfide, chlorinated polyether, or polyarylsulfone; and/or
the binder is selected from one, two, or more of polytetrafluoroethylene, polyvinylidene fluoride, a polyvinylidene fluoride-hexafluoropropylene copolymer, hexafluoropropylene modified polyvinylidene fluoride, polyimide, polyacrylonitrile, polymethyl methacrylate, cellulose acetate, butyl acetate cellulose, propyl acetate cellulose, cyanoethyl amylopectin, cyanoethyl polyvinyl alcohol, cyanoethyl cellulose, cyanoethyl sucrose, amylopectin, carboxymethyl cellulose, or an acrylonitrile styrene butadiene copolymer.

8. The separator according to claim 1, wherein the adhesive layer comprises an adhesive polymer; and/or
the adhesive polymer is selected from one, two, or more of polytetrafluoroethylene, polyvinylidene fluoride, a polyvinylidene fluoride-hexafluoropropylene copolymer, hexafluoropropylene modified polyvinylidene fluoride, polyimide, polyacrylonitrile, polymethyl methacrylate, cellulose acetate, butyl acetate cellulose, propyl acetate cellulose, cyanoethyl amylopectin, cyanoethyl polyvinyl alcohol, cyanoethyl cellulose, cyanoethyl sucrose, amylopectin, carboxymethyl cellulose, or an acrylonitrile styrene butadiene copolymer; and/or
in the adhesive layer, a mass proportion of the adhesive polymer ranges from 40 wt % to 100 wt %.

9. A battery, wherein the battery comprises the separator according to claim 1.

10. The battery according to claim 9, wherein the battery further comprises a positive electrode plate, a negative electrode plate, and a non-aqueous electrolyte solution; and the non-aqueous electrolyte solution comprises a non-aqueous organic solvent, an additive, and a lithium salt, and the non-aqueous organic solvent comprises ethyl propionate.

11. The battery according to claim 9, wherein an addition amount of the ethyl propionate is 10-50 wt % of a total mass of the non-aqueous electrolyte solution; and/or
the lithium salt accounts for 13-20 wt % of a total mass of the non-aqueous electrolyte solution.

12. A battery, comprising a positive electrode plate, a negative electrode plate, a separator disposed between the positive electrode plate and the negative electrode plate, and a non-aqueous electrolyte solution;
the separator is the separator according to claim 1; and
the non-aqueous electrolyte solution comprises a non-aqueous organic solvent, an additive, and a lithium salt, wherein the non-aqueous organic solvent comprises ethyl propionate, and the additive comprises a carbonate compound.

13. The battery according to claim 12, wherein the carbonate compound accounts for 1-10 wt % of a total mass of the non-aqueous electrolyte solution; and/or
an addition amount of the ethyl propionate is 10-40 wt % of a total mass of the non-aqueous electrolyte solution.

14. The battery according to claim 12, wherein the additive further comprises another additive, and the another additive is at least one of tris(trimethyl)silane phosphite, tris(trimethylsilyl) borate, lithium bis(trifluoromethanesulphonyl)imide, lithium bis(fluorosulfonyl)imide, 1,3-propanesulfonate, 1,3-propenesultone, ethylene sulphite, ethylene sulfate, vinylene carbonate, fluoroethylene carbonate, lithium bis(oxalate)oborate, lithium difluoro(oxalate)borate, lithium difluoro(oxalate) phosphate or vinyl ethylene carbonate; and/or
an addition amount of the another additive accounts for 0-10 wt % of a total mass of the non-aqueous electrolyte solution.

15. The battery according to claim 12, wherein the non-aqueous organic solvent further comprises at least one of ethylene carbonate, propylene carbonate, dimethyl carbonate, diethyl carbonate, ethyl methyl carbonate, propyl propionate, or propyl acetate.

16. The battery according to claim 12, wherein in the separator, a ratio of A to B ranges from 1.5 to 6.0.

17. A battery, comprising a positive electrode plate, a negative electrode plate, a separator disposed between the positive electrode plate and the negative electrode plate, and a non-aqueous electrolyte solution;
the separator is the separator according to claim 1; and
the non-aqueous electrolyte solution comprises a non-aqueous organic solvent, an additive, and a lithium salt, wherein the non-aqueous organic solvent comprises ethyl propionate, and the additive comprises a compound comprising a nitrile group.

18. The battery according to claim 17, wherein an addition amount of the ethyl propionate is 10-40 wt % of a total mass of the non-aqueous electrolyte solution; and/or an addition amount of the compound comprising a nitrile group accounts for 1-10 wt % of a total mass of the non-aqueous electrolyte solution.

19. The battery according to claim 17, wherein the compound comprising a nitrile group is selected from at least one of succinonitrile, glutaronitrile, adiponitrile, 1,5-dicyanopentane, 1,6-dicyanohexane, 1,7-dicyanoheptane, 1,8-dicyanooctane, 1,9-dicyanononane, 1,10-dicyanodecane, 1,12-dicyanododecane, tetramethylbutadionitrile, 2-methylglutaronitrile, 2,4-dimethylglutaronitrile, 2,2,4,4-Tetramethylglutaronitrile, 1,4-dicyanopentane, 2,6-dicyanoheptane, 2,7-dicyanooctane, 2,8-dicyanononane, 1,6-dicyanodecane, 1,2-dicyanobenzene, 1,3-dicyanobenzene, 1,4-dicyanobenzene, 3,5-dioxa-heptadionitrile, 1,4-bis(cyanoethoxy)butane, ethylene glycol bis(2-cyanoethyl) ether, diethylene glycol bis(2-cyanoethyl) ether, triethylene glycol bis(2-cyanoethyl) ether, tetraethylene glycol bis(2-cyanoethyl) ether, 3,6,9,12,15,18-hexaoxeicosanic acid dinitrile, 1,3-bis(2-cyanoethoxy)propane, 1,4-bis(2-cyanoethoxy) butane, 1,5-bis(2-cyanoethoxy)pentane, ethylene glycol bis(4-cyanobutyl) ether, 1,4-dicyano-2-butene, 1,4-dicyano-2-methyl-2-butene, 1,4-dicyano-2-ethyl-2-butene, 1,4-dicyano-2,3-dimethyl-2-butene, 1,4-dicyano-2,3-diethyl-2-butene, 1,6-dicyano-3-hexene, 1,6-dicyano-2-methyl-3-hexene, 1,6-dicyano-2-methyl-5-methyl-3-hexene, 1,3,5-pentatrionitrile, 1,2,3-propanetricarbonitrile, 1,3,6-hexane trinitrile, glycerol trinitrile, 1,2,6-hexane trinitrile, 1,2,3-tri(2-cyanoethoxy)propane, 1,2,4-tri(2-cyanoethoxy) butane, 1,1,1-tri(cyanoethoxymethylene)ethane, 1,1,1-tri(cyanoethoxymethylene)propane, 3-methyl-1,3,5-tri(cyanoethoxy)pentane, 1,2,7-tri(cyanoethoxy)heptane, 1,2,6-tri(cyanoethoxy) hexane, or 1,2,5-tri(cyanoethoxy)pentane.

20. The battery according to claim 17, wherein in the separator, a ratio of A to B ranges from 1.5 to 4.5.
